(19) United States
(12) Patent Application Publication
(10) Pub. No.: US 2014/0124518 A1
(43) Pub. Date: May 8, 2014

(54) INSULATING CUP AND METHOD FOR PRODUCING AN INSULATING CUP

(71) Applicants: Werner STAHLECKER, Goeppingen (DE); Andreas STROEHLE, Steinenkirch (DE)

(72) Inventors: Werner STAHLECKER, Goeppingen (DE); Andreas STROEHLE, Steinenkirch (DE)

(21) Appl. No.: 14/068,026

(22) Filed: Oct. 31, 2013

(30) Foreign Application Priority Data
Nov. 5, 2012 (DE) 10 2012 220 112.2

(51) Int. Cl. B65D 81/38; B31C 5/00; B31D 5/00

(52) U.S. Cl. CPC B65D 81/3876; B31D 5/0086; B31C 5/00
USPC 220/739; 493/287; 493/296

(57) ABSTRACT

An insulating cup including an essentially liquid-tight inner cup and an outer sleeve enveloping the inner cup at least in sections, with the outer sleeve including a blank made of paper material and an insulating layer applied on the paper material. The insulating layer is applied merely on a partial section of the blank, wherein an overlapping region of the blank, in which region the outer sleeve has a material thickness at least twice the thickness of the paper material, is not provided with the insulating layer.

### CROSS REFERENCE TO RELATED APPLICATION

This application claims priority from German Application No. 10 2012 220 112.2, filed Nov. 5, 2012, the disclosure of which is hereby incorporated by reference in its entirety into this application.

### FIELD AND SUMMARY OF THE INVENTION

The invention relates to an insulating cup comprising an essentially liquid-tight inner cup and an outer sleeve enveloping the inner cup at least in sections, with the outer sleeve including a blank made of paper material and a basically two-dimensional insulating material applied on the paper material. The invention also relates to a method for producing an insulating cup comprising an inner cup and an outer sleeve enveloping the inner cup at least in sections, with the outer sleeve being formed from a basically two-dimensional blank made of paper material and a two-dimensional insulating material applied on the paper material.

The aim of the invention is to provide an improved insulating cup and an improved method for producing an insulating cup.

According to the invention, an insulating cup comprising an essentially liquid-tight inner cup and an outer sleeve enveloping the inner cup at least in sections is provided, with the outer sleeve including a blank made of paper material and a basically two-dimensional insulating material applied on the paper material, where the insulating material is applied merely on a partial section of the blank, wherein an overlapping region of the blank, in which region the outer sleeve has a material thickness at least twice the thickness of the paper material, is not provided with the insulating material.

In that an overlapping region of the blank, in which region the outer sleeve has a material thickness at least twice the thickness of the paper material, remains exposed and is not provided with the insulating layer, the paper material of the outer sleeve can be interconnected regardless of an insulating layer provided, and the insulating layer and the insulating material, respectively, can also be selected to have an extensive thickness, without an unduly increased wall thickness of the outer sleeve formed in the overlapping region. Surprisingly, it has been found that even in case that not only the overlapping region, but a larger region remains exposed and is not provided with the insulating material, the insulating characteristics of the cup would be deteriorated but to a negligible extent. Exposing a larger region than the actual overlapping region can be advantageous also to the effect that contingent tolerances during assembling the blank to the outer sleeve can be compensated without difficulty.

In an advanced embodiment of the invention, the basically two-dimensional insulating material is made of foam material.

In an advanced embodiment of the invention, the two-dimensional insulating material is made of a wood-type material, in particular wood veneer.

In an advanced embodiment of the invention, the two-dimensional insulating material is made of material including natural fibers, in particular cotton fibers.

In an advanced embodiment of the invention, the inner cup has a cone-type shape and the blank has a segment of a circle-type shape.

In an advanced embodiment of the invention, the lateral edges of the blank are disposed perpendicular to the curved upper edge and lower edge of the blank, with the approximately rectangular overlapping region of the blank remaining exposed.

In an advanced embodiment of the invention, there is an additional approximately triangular region remaining exposed besides the rectangular overlapping region, the triangular region enlarging from the shorter lower edge towards the longer upper edge.

In this manner, an exposed region free of insulating material remains and can be used for compensation of tolerances. Furthermore, cutting the blanks from strip-shaped or lamellar material is considerably facilitated, as the lateral edges of the insulating material may extend in parallel to one another.

In an advanced embodiment of the invention, the two-dimensional insulating material rests immediately on an exterior wall of the inner cup.

In an advanced embodiment of the invention, the two-dimensional insulating material is arranged spaced from the exterior wall of the inner cup at least in sections.

In an advanced embodiment of the invention, the inner cup has at least one protrusion projecting inwards in the vicinity of its bottom half, wherein the protrusion takes the form of an abutment surface for a lower edge of the outer sleeve of a similar insulating cup inserted into the inner cup.

Since the outer sleeve is composed of a paper material and an insulating layer applied on the paper material, the outer sleeve has an increased thickness as compared to a plain paper layer. Thereby, the lower edge of the outer sleeve can be used immediately for stacking on a protrusion of the inner sleeve.

In an advanced embodiment of the invention, the outer sleeve rests in a planar manner on an exterior wall of the inner cup in the vicinity of the lower edge of the outer sleeve.

In this manner, the lower edge used for stacking can be constructed in a very sturdy design, since the edge can take planar support on the exterior wall of the inner cup. In the vicinity of the lower edge the outer cup can be connected to the exterior wall of the inner cup by material engagement, to stabilize the lower edge used for de-stacking.

The object of the invention is also solved by a method for producing an insulating cup comprising an inner cup and an outer sleeve enveloping the inner cup at least in sections, with the outer sleeve being formed from a two-dimensional blank made of paper material and a two-dimensional insulating material applied on the paper material, wherein applying of the two-dimensional insulating material onto a partial section of the two-dimensional paper material and producing of the blank made of paper material is provided, wherein at least one overlapping region of the blank made of paper material, in which the outer sleeve has a material thickness at least twice the thickness of the paper material, remains exposed and is not covered with the insulating material.

Surprisingly, simply leaving at least the overlapping region exposed is successful to substantially improve a method for producing an insulating cup. Indeed, applying the insulating material is to a minor extent more elaborate than the full-surface applying of insulating material, since actually at least the overlapping region has to be kept exposed, however, during producing the outer sleeve by connecting the paper material in the overlapping region the production of the outer sleeve is essentially facilitated.

In an advanced embodiment of the invention, the applying of the two-dimensional insulating material onto a partial section of the two-dimensional paper material is performed prior to producing a blank for the outer sleeve from the paper material partially provided with the insulating material.

This manner allows initially to apply insulating material on a large area of paper material and not earlier than upon completion are the blanks for production of the outer sleeve manufactured from the then obtained laminate, for example by punching or cutting.

In an advanced embodiment of the invention, the applying of a two-dimensional insulating material in the form a material strip onto a paper material in the form a material strip is provided, wherein as viewed in the longitudinal direction of the material strip at least one rectangular or lamellar section of the paper material remains exposed, and not earlier than upon completion is the blank for the outer sleeve cut out or punched out.

In this manner, for example the insulating material and the paper material can each be supplied from a coil or spool and by skillful arrangement of the material strip made of insulating material on the paper material and subsequent appropriate arrangement of the blank on this laminate, a blank for producing the outer sleeve can successfully be prepared with very low effort, whereby at least the overlapping region is free of insulating material.

In an advanced embodiment of the invention, the cutting out or punching out of the blank for the outer sleeve is performed in a manner that a lateral edge of the blank, to which edge the overlapping region adjoins, is arranged non-parallel to a first lateral edge of the material strip.

In this manner, besides the approximately rectangular overlapping region an additional approximately triangular region of the paper material remains exposed and free of insulating material. Said triangular region can be used for compensation of tolerances, and particularly the handling of the cut out blanks is facilitated thereby in that the blanks do not need to be turned or repositioned for further processing, but can be processed further in a direction parallel to the feeding direction of the material strips.

In an advanced embodiment of the invention, the cutting out or punching out of the blank for the outer sleeve is performed in a manner that a lateral edge of the blank, to which edge the overlapping region adjoins, is arranged parallel to a first lateral edge of the material strip.

This manner allows that indeed only the overlapping region remains exposed and free of insulating material. Thus, the insulation material can extend essentially completely around the circumference of the inner cup and between the front edges of the insulating material there is at the most a narrow gap remaining that is inessential for insulating characteristics.

Further features and advantages of the invention will become apparent from the claims and the following description of preferred embodiments of the invention in connection with the drawings. Individual features of the different embodiments as illustrated in the drawings may be combined with one another in arbitrary manner, without extending beyond the scope of the invention. In the drawings:

### BRIEF DESCRIPTION OF THE DRAWINGS

FIG. 1 is a partially sectional view of two stacked insulating cups according to a first preferred embodiment of the invention;

FIG. 2 is a sectional view of one of the insulating cups of FIG. 1;

FIG. 3 is a view on sectional plane III-III of FIG. 2;

FIG. 4 is an enlarged illustration of detail IV in FIG. 2;

FIG. 5 is a top view on a blank for producing the outer sleeve of the insulating cup of FIG. 1;

FIG. 6 is a top view on a laminate made of paper material and insulating material with thereon indicated contours of segments for producing the outer sleeves of the insulating cups of FIG. 1;

FIG. 7 is a top view on a laminate made of insulating material and paper material with thereon indicated blanks for producing the outer sleeves of the insulating cups of FIG. 1 and a conveyor belt intended for evacuation of the cut segments;

FIG. 8 is a sectional view of an insulating cup according to the invention in another embodiment of the invention;

FIG. 9 is a sectional view of two stacked insulating cups according to another embodiment of the invention;

FIG. 10 is an illustration of detail X in FIG. 9;

FIG. 11 is a partially sectional side elevation of two insulating cups according to FIG. 9;

FIG. 12 is an enlarged illustration of detail XII in FIG. 11;

FIG. 13 is a sectional view of two stacked insulating cups according to another embodiment of the invention;

FIG. 14 is an illustration of detail XIV in FIG. 13;

FIG. 15 is a partially sectional view of two stacked insulating cups according to another embodiment of the invention;

FIG. 16 is an enlarged illustration of detail XVI in FIG. 15; and

FIG. 17 is a sectional view of an insulating cup according to the invention in another embodiment of the invention.

### DETAILED DESCRIPTION

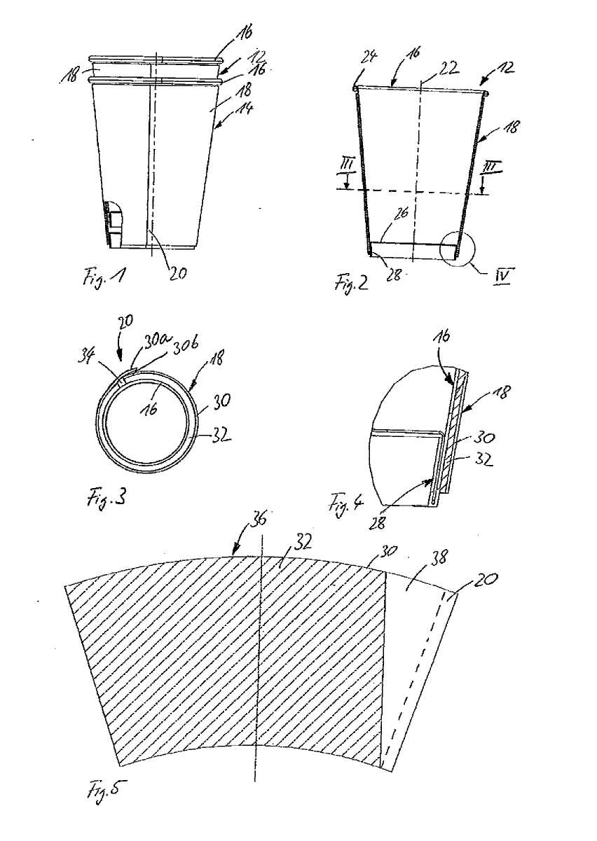

In the illustration of FIG. 1 are two insulating cups 12 and 14 according to the invention designed in an identical shape and stacked one into the other. Each of the insulating cups 12 and 14 has an inner cup 16 made of paper material and an outer sleeve 18. The inner cup 16 has an upper lip rim or lip roll 24 and is in a frustoconical shape. The outer sleeve 18 also has a frustoconical design and the interior surface of the jacket rests planar on the exterior surface of the inner cup 16. The outer sleeve 18 ends a short length below the upper lip rim 24 of the inner cup 16 and a short length above the lower edge of the inner cup 16, which lower edge is constituted by the lower edge of a peripheral bottom shroud or skirt 28.

The outer sleeve 18 is wound into a frustoconical shape from a blank, wherein the ends of the blank are connected in a rectangular overlapping region 20, for example adhesively bonded or sealed, wherein cold glue, hot-melt adhesive, hot-melt sealant, or even hot-melt sealing film coatings may be employed.

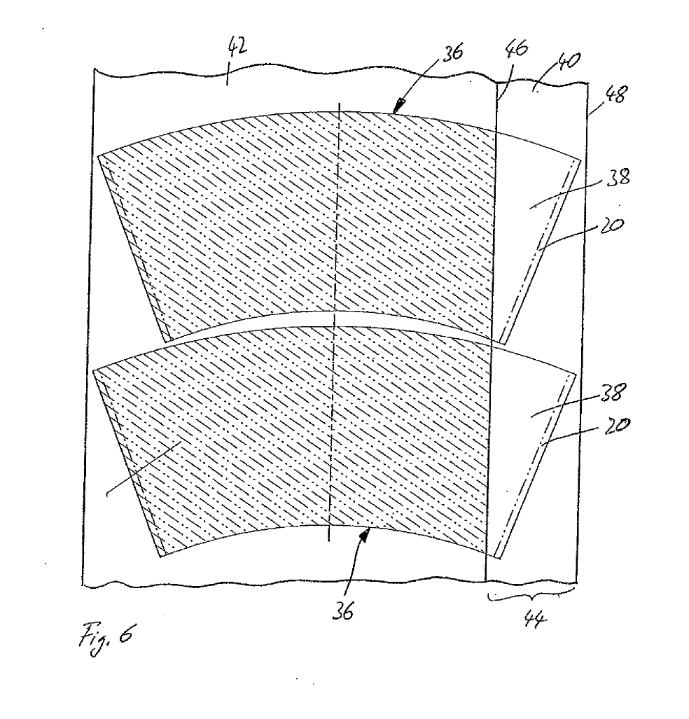

The illustration of FIG. 2 shows a view on a sectional plane traversing a central axis 22 of the insulating cup 12. Apparent are the upper lip rim 24 of the inner cup 16, the bottom 26 of the cup, and the peripheral bottom skirt 28, by means of which the bottom 26 and the frustoconical wall of the inner cup 16 are connected in a liquid-tight manner.

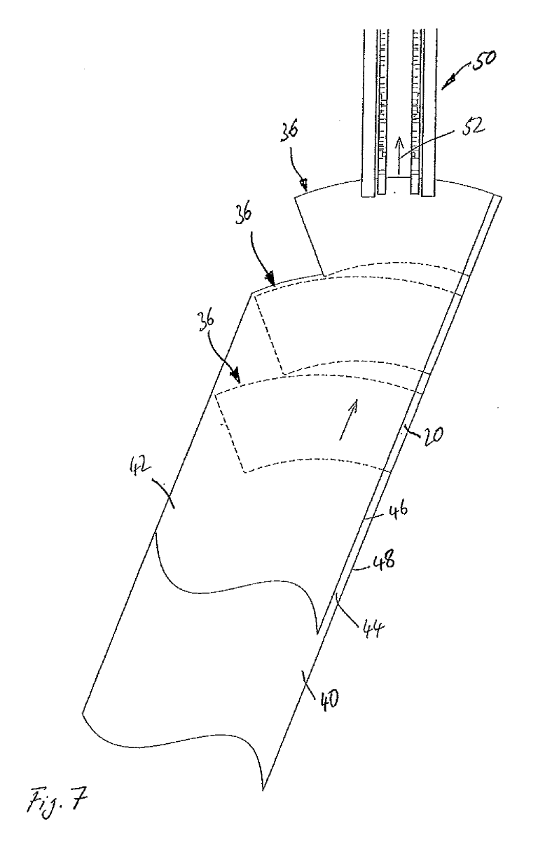

The illustration of FIG. 4 shows the detail IV of FIG. 2 and allows a more explicit view of the design of the bottom skirt 28.

The structural design of the outer sleeve 18 is also apparent in FIG. 4. The outer sleeve 18 is composed of a blank made of two-dimensional paper material 30, which is provided on the interior surface thereof with an insulating layer in the form of a two-dimensional material 32, which again is resting planar on the exterior surface of the inner cup 16. The outer sleeve 18 can simply be slid on the inner cup 16, for example, but can also be adhesively bonded to the cup in sections or over the entire surface.

The illustration of FIG. 3 shows a diagrammatic sectional view of the sectional plane III-III in FIG. 2. What is indicated is the circumferential wall of the inner cup 16, with the outer sleeve 18 applied on the exterior surface of the inner cup, for example slid on. The outer sleeve 18 is composed of a wound blank made of the exterior two-dimensional paper material 30 and the two-dimensional insulating material 32, for example a foam material layer, which is interposed between the inner cup 16 and the paper material 30. As apparent from FIG. 3, in the overlapping region 20 the interior surface of the exterior section of the paper material 30 is not provided with the two-dimensional insulating material 32. Thus, the exterior section 30a of the paper material 30 in the overlapping region 20 can be applied immediately on the interior section 30b of the paper material 30 in the overlapping region 20 and the two sections 30a, 30b can be interconnected by adhesive bonding or sealing to one another, for example.

As illustrated in FIG. 3, the insulating layer ends in front of the overlapping region 20, as viewed in the circumferential direction, so that a gap 34 is formed between the inner cup 16 and the outer paper layer 30 adjacent to the overlapping region 20. Said gap 34 is produced in that yet another section of the insulating layer remains exposed in addition to the overlapping region 20. The gap 34 does not deteriorate the insulating characteristics of the insulating cup 12, or only to an inessential extent, and furthermore can be used to compensate tolerances which are likely to occur during manufacture of the outer sleeve 18.

The illustration of FIG. 5 shows a two-dimensional blank 36 which is used to produce the outer sleeve 18. The blank 36 is designed in the shape of a segment of a circle and is adapted to be wound in the frustoconical shape of the outer sleeve 18. For producing the outer sleeve 18, the two-dimensional blank 36 is wound around a frustoconical mandrel or even wound immediately around the inner cup 16, for example. The rectangular overlapping region 20, indicated by a dashed line in FIG. 5, is placed with its interior surface, turned towards the viewer in FIG. 5, on the exterior surface of the opposite lateral edge of the two-dimensional blank 36 and connected to said exterior surface, as illustrated in FIG. 3.

Besides the approximately rectangular overlapping region 20, as illustrated in FIG. 5, there is a second, approximately triangular region 38 remaining without insulating material 32 applied, so that in the overlapping region 20 and in the region 38 the paper material 30 is free of the insulating layer 32.

Consequently, the gap 34 indicated in FIG. 3 varies in width as viewed over the height of the cup. At the lower end of the outer sleeve 18 the gap 34 would have a width of approximately zero and would gradually enlarge towards the upper end of the outer sleeve 18, that is, to the larger diameter thereof. As already discussed, the gap 34 does not deteriorate the insulating characteristics of the insulating cup 12, or only to an inessential extent.

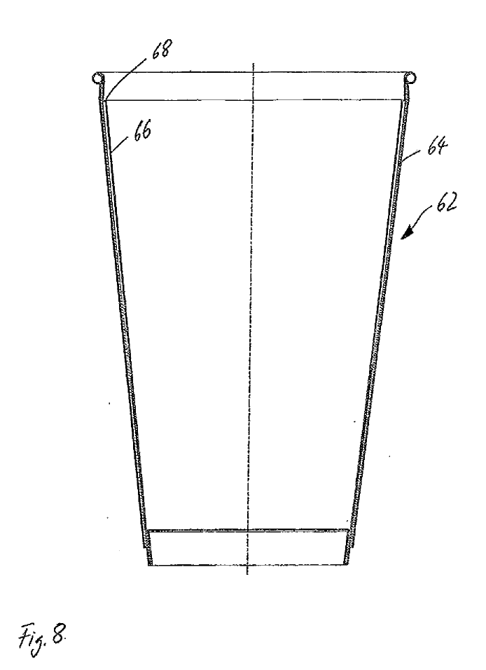

The illustration of FIG. 6 demonstrates the reason why providing the approximately triangular region 38 besides the overlapping region 20 considerably facilitates the production of the two-dimensional blanks 36. For producing the segments, initially a cardboard or paper strip 40 is unwound from a coil, and a foam material strip 42, equally unwound from a coil, is then laminated onto the paper strip 40, for example by adhesive bonding. Instead of the foam material strip 42, any other two-dimensional insulating material may be employed as well. However, the foam material strip 42 is less wide than the paper strip 40, so that a strip-shaped or lamellar section 44 of the laminate composed of paper strip 40 and foam material strip 42 is formed, wherein no foamed material is applied on the paper strip 40.

The blanks 36 are then punched from the laminate such that the straight lateral edges on both ends of the blanks are each arranged at the same angle relative to the lateral edges of the laminate, and thus the blanks 36 are centrally punched or cut out of the laminate. Indeed, the lateral edge of the foam material strip 42 on the right hand side in the illustration of FIG. 6 extends in parallel to the right lateral edge 48 of the paper strip 40, but at a distance to said lateral edge 48. Thus, after cutting out the blanks 36, there is not only the overlapping region 20 remaining free of foamed material, but in addition also the approximately triangular region 38 remains exposed. However, the blanks 36 can be punched out centrally to the paper strip 40 and as a consequence moved off parallel to the lateral edges 48, 46 even after punching. Thereby an automated manufacture of the insulating cups 12 is facilitated considerably and the structure of the machines required therefor is simplified.

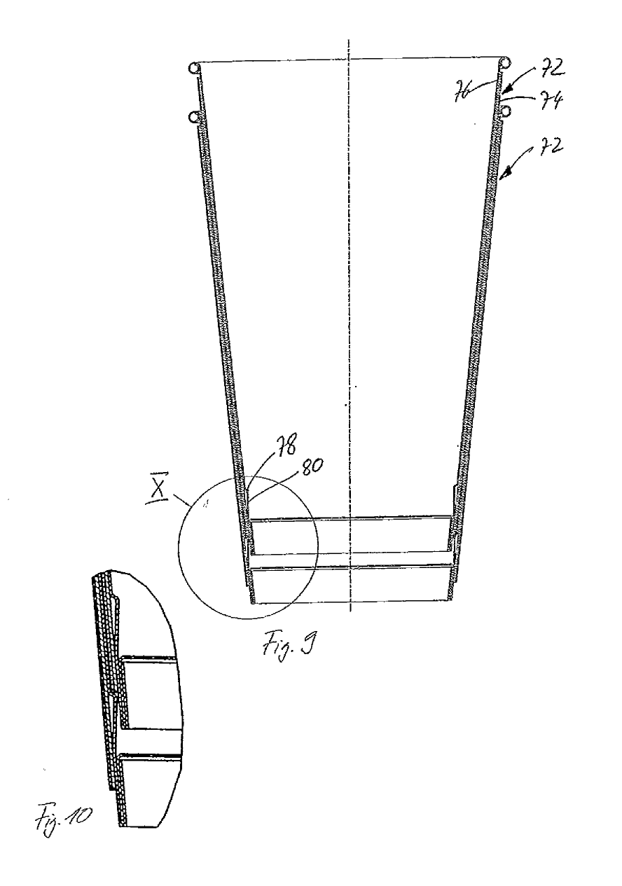

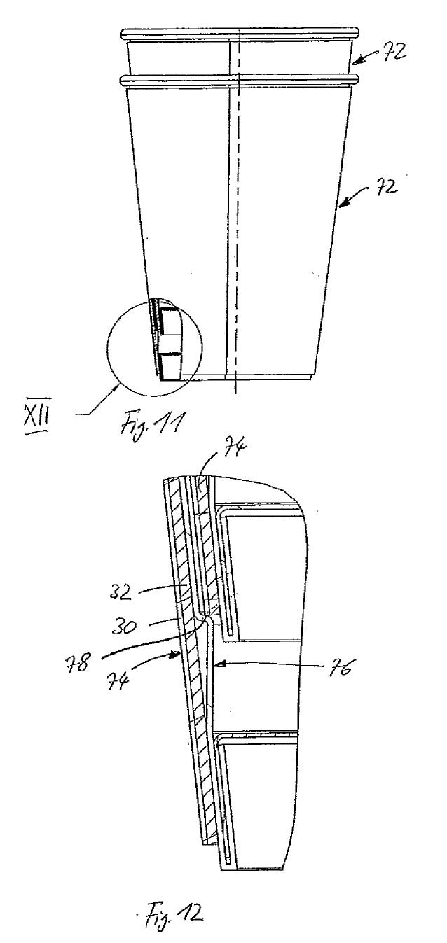

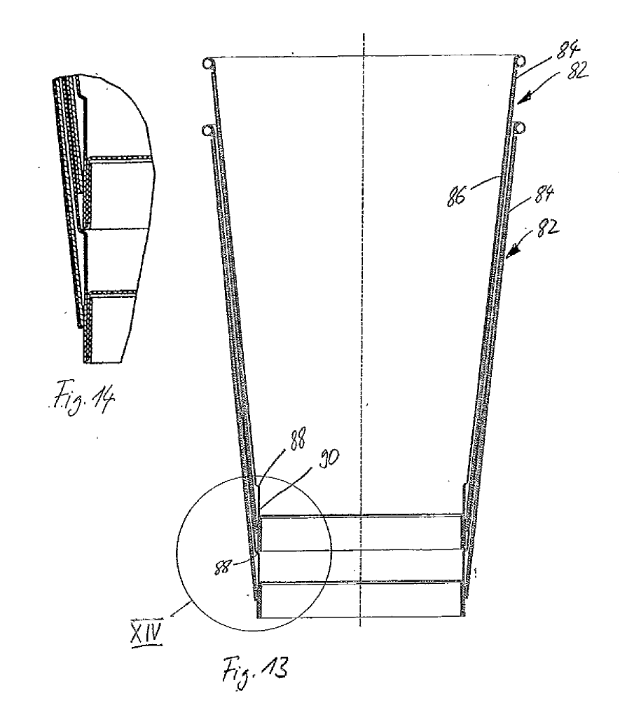

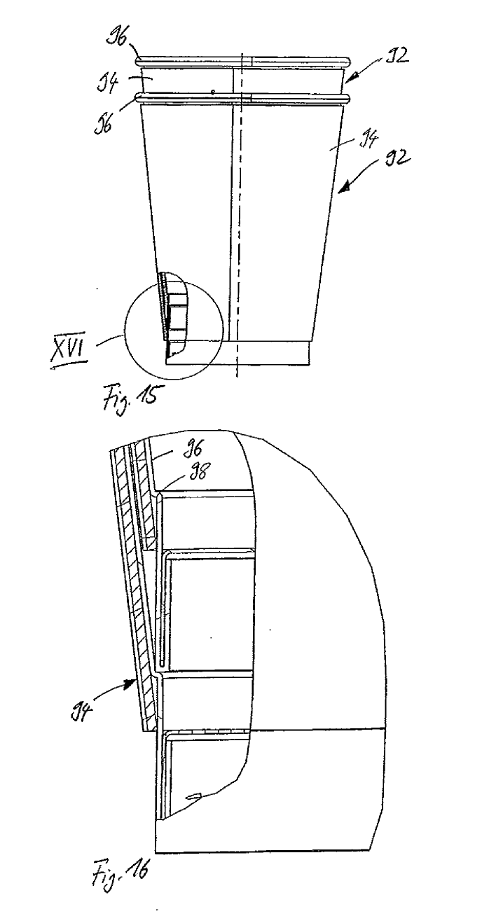

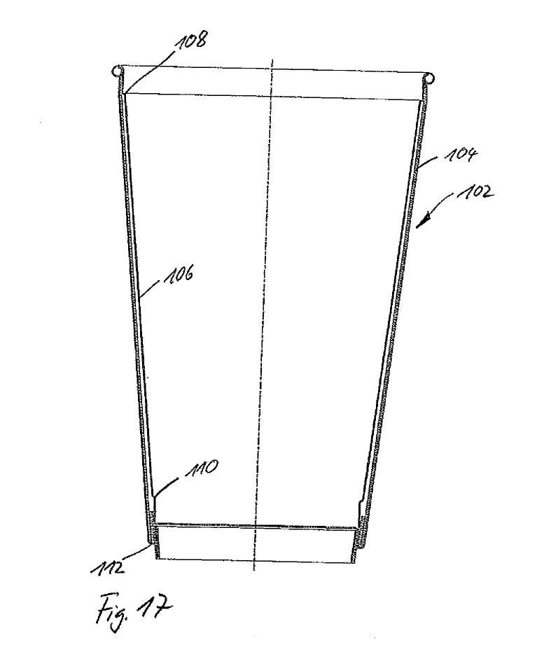

The illustration of FIG. 7 shows a diagrammatic plan view on the laminate composed of the paper strip 40 and the foam material strip 42, wherein again the paper strip 40 and the foam material strip 42 are drawn off a coil in a manner not illustrated and interconnected over their surfaces. Between the lateral edge 46 of the foam material strip 42, on the right hand side in FIG. 7, and the lateral edge 48 of the paper strip 40, on the right hand side in FIG. 7, there is again a section 44 remaining in which the paper strip 40 is not covered by the foam material strip 42. The width of the section 44 is correspondent to the width of the overlapping region 20 of the blanks 36 in the embodiment of FIG. 7. For that purpose, the blanks 36 are punched from the laminate in such a manner that the lateral edge adjoining the overlapping region 20 is coincident with the lateral edge 48 of the paper strip 40. As apparent in the illustration of FIG. 7, thereby the blanks 36 can actually not be punched from the laminate in a central position and would have to be turned for further processing, as the case may be, to be moved off via a conveyor belt 50 and optional grippers. However, an advantageous solution to this problem could be that the paper strip 40 and the foam material strip 42 are supplied obliquely to the conveyor belt 50, and the blanks 36 then be punched out or cut out in such a manner that their axes of symmetry are parallel to a conveying direction 52 of the conveyor belt 50.

The illustration of FIG. 8 shows a sectional view of an insulating cup 62 according to the invention in another preferred embodiment of the invention.

In contrast to the insulating cup 12 according to FIG. 2, an outer sleeve 64 is not resting flush on the exterior wall of the inner cup 66 over the entire height of the jacket. Instead, the inner up 66 has a shoulder 68 projecting inwards in the upper portion of the cup. Thereby, the outer sleeve 64, again composed of a laminate made of an exterior paper layer and an interior insulating layer, is resting in a planar manner on the inner cup 66 merely in a region between the upper lip rim and the upper shoulder 68, and below the upper shoulder 68 a distance between outer sleeve 64 and inner cup 66 decreases gradually, until the outer sleeve 64 in the region of the lower end thereof rests again in a planar manner on the inner cup 66.

The illustration of FIG. 9 shows a sectional view of two insulating cups 72 stacked one into the other according to another embodiment of the invention; and the illustration of FIG. 10 shows the Detail X of FIG. 9.

The insulating cups 72 each include an outer sleeve 74 and an inner cup 76. The inner cup 76 is provided with a shoulder 78 projecting inwards a short length above the bottom of the cup. The insulating jacket rests in a planar manner on the exterior surface of the inner cup 76 with the exception of the region of the shoulder 78 and a cylindrical section 80 disposed below the shoulder 78. The shoulder 78 is for de-stacking of a plurality of stacked insulating cups 72, and in the stacked condition a lower edge of the outer sleeve 74 is supported on the shoulder 78 of the respective cup sitting thereunder. Since the outer sleeve 74 above the shoulder 78 and below the cylindrical section 80, in other words, below the shoulder 78, is resting planar on the inner cup 76 and advantageously connected to the inner cup 76 above and below the shoulder 78, for example adhesively bonded, the outer sleeve 74 is adapted to reinforce the shoulder 78 such that multiple insulating cups 12 can readily be stacked into one another, without the shoulder 78 yielding, and without jamming of the insulating cups 72.

The illustration of FIG. 11 shows the insulating cups 12 of FIG. 9 in a partially sectional side elevation.

The illustration of FIG. 12 shows that the outer sleeve 74 is composed of an exterior layer made of paper material 30 and an interior layer made of insulating material 32, and that the insulating material 32 above and below the shoulder 78 rests on the inner cup 76 in a planar manner on the exterior surface of the inner cup 76. Furthermore, FIG. 12 shows that the lower edge of the outer sleeve 74 of the upper cup supports on the shoulder 78 of the lower cup, and thereby prevents that the upper cup slides too far into the lower cup and as a result the two stacked insulating cups 72 become wedged together.

The illustrations of FIG. 13 and FIG. 14 show a sectional view of two stacked insulating cups according to another preferred embodiment of the invention. The insulating cups 82 each have an outer sleeve 84 made of paper material and an interior insulating layer and an inner cup 86. The outer sleeve 84 has a slightly different, namely greater angle of taper than the inner cup 86, and is resting planar on the inner cup 86 in the region below the upper lip rim. Over the extension of the inner cup and the outer sleeve downwards the distance between outer sleeve 84 and inner cup 86 is increasing. Above the bottom the inner cup 86 is provided with a shoulder 88 projecting inwards, to which a conically enlarging section 90 adjoins in the direction towards the bottom and the lower edge of the inner cup 86. Even the peripheral bottom skirt of the inner cup 86 is slightly flaring outwards. Thus, the lower edge of the bottom skirt of the respective upper cup can take support on the shoulder 88 on the inner cup 86 of the respective lower cup, and thereby prevent that the two stacked insulating cups 82 become jammed, even if multiple insulating cups 82 are stacked into one another. As apparent in FIG. 13 and FIG. 14, the respective outer sleeve 84 of the insulating cup 82 ends below the bottom.

The illustrations of FIG. 15 and FIG. 16 respectively show stacked insulating cups 92 according to another preferred embodiment of the invention. The insulating cups 92 each include an outer sleeve 94 and an inner cup 96, wherein, as illustrated in FIG. 16, the outer sleeves 94 are arranged with their bottom edge approximately at the level of the bottom of the inner cups 96. The inner cups have, as explained with reference to the inner cups 82 of FIG. 13 and FIG. 14, above the bottom a shoulder 98 projecting inwards and below the shoulder 98 the inner cup 96 is again enlarging up to the lower edge of the bottom skirt. Upon stacking of a plurality of cups, the lower edge of the bottom skirt of the upper cup can thereby take support on the shoulder 98 of the respective lower cup. This is effective to prevent that even with a plurality of insulating cups 92 stacked one into the other, there is no jamming of the cups.

It is also noted that due to the measure according to the invention that at least the overlapping region of the blank for the outer sleeve 94 remains free of the insulating material, the thickness of the outer sleeve 94 even in the overlapping region is thicker by not more than the material thickness of the exterior paper material as compared to the other circumferential zones. It is essentially the feature according to the invention that at least the overlapping region is left exposed that actually allows to provide the insulating cup 92 with a thick outer sleeve 94, which is covered by an insulating layer on its interior surface, and regardless thereof implement the feature of stacking the cups, as illustrated in FIG. 16 and FIG. 15.

The illustration of FIG. 17 shows an insulating cup 102 according to another preferred embodiment of the invention. The insulating cup 102 includes an outer sleeve 104 made of an exterior paper layer and an interior insulating layer. The insulating cup 102 further includes an inner cup 106 which is provided in its upper portion below the upper lip rim with an upper, inwards projecting shoulder 108 and a short length above the bottom with a lower, inwards projecting shoulder 110. The outer sleeve 104 rests planar on the inner cup 106 in a region between the upper lip rim and the upper shoulder 108, and is then arranged at a constant distance to the inner cup 108 up to the lower shoulder 110. A lower edge of the outer sleeve 104 is bent or folded over and flattened. Thereby, the lower part of the sleeve is reinforced considerably. The insulating layer can also be molten, provided that it is made of meltable material, and sealed together subsequent to folding over. In this case, the outer sleeve 104 is sealed to the inner cup 106 in the vicinity of the foldover. As a result, the stability of the sleeve is improved essentially, which is highly advantageous in particular for a later de-stacking of multiple cups. With thick insulating layers, melting the insulating layer is appropriate to significantly facilitate the folding over. A surface of the foldover 104 provided with the insulating layer is then resting on an exterior surface of the inner cup 106, in sections above the bottom and in sections below the bottom of the inner cup 106. A lower edge 112 is disposed below the bottom of the inner cup 106 and can be supported by the lower shoulder 110 of the inner cup 106 in the stacked condition of multiple cups. This is to prevent that a plurality of stacked insulating cups 102 become jammed into one another. The insulating cup 102 presents extraordinarily high insulating characteristics, since an air gap is present between the inner cup 106 and the outer sleeve 104, and furthermore the insulating layer on the interior surface of the outer sleeve 104 provides for good insulation. Even in case that the insulating cup 102 is compressed locally and thus the outer sleeve 104 abuts the outer wall of the inner cup 106, the insulating layer on the interior surface of the outer sleeve 104 continues to provide for reliable insulation.

1. An insulating cup comprising an essentially liquid-tight inner cup and an outer sleeve enveloping the inner cup at least in sections, with the outer sleeve including a blank made of paper material and a basically two-dimensional insulating material applied on the paper material,
wherein
the two-dimensional insulating material is applied merely on a partial section of the blank, wherein an overlapping region of the blank, in which region the outer sleeve has a material thickness at least twice the thickness of the paper material, is not provided with the insulating material.

2. The insulating cup according to claim 1, wherein the two-dimensional insulating material is made of foam material.

3. The insulating cup according to claim 1, wherein the two-dimensional insulating material is made of two-dimensional, wood-type material, in particular wood veneer.

4. The insulating cup according to claim 1, wherein the two-dimensional insulating material is made of material including natural fibers, in particular cotton fibers.

5. The insulating cup according to claim 1, wherein the inner cup has a frustoconical shape and the blank has a segment of a circle shape.

6. The insulating cup according to claim 5, wherein the lateral edges of the blank are disposed perpendicular to the curved upper edge and lower edge of the blank, wherein the approximately rectangular overlapping region of the blank remains exposed.

7. The insulating cup according to claim 6, wherein besides the rectangular overlapping region an additional approximately triangular region remains exposed, the triangular region enlarging from the shorter lower edge towards the longer upper edge of the blank.

8. The insulating cup according to claim 1, wherein the two-dimensional insulating material rests immediately on an exterior wall of the inner cup.

9. The insulating cup according to claim 1, wherein the two-dimensional insulating material is arranged spaced from the exterior wall of the inner cup at least in sections.

10. The insulating cup according to claim 1, wherein the inner cup has at least one protrusion projecting inwards in the vicinity of its bottom half, wherein the protrusion takes the form of an abutment surface for a lower edge of the outer sleeve of a similar insulating cup inserted into the inner cup.

11. The insulating cup according to claim 10, wherein the outer sleeve rests in a planar manner on an exterior wall of the inner cup in the vicinity of the lower edge of the outer sleeve.

12. The insulating cup according to claim 10, wherein the outer sleeve in the vicinity of its lower edge is connected to the inner cup by material engagement, in particular by sealing of the insulating material thereto.

13. A method for producing an insulating cup comprising an essentially liquid-tight inner cup and an outer sleeve enveloping the inner cup at least in sections, with the outer sleeve being formed of a blank made of paper material and a two-dimensional (planar) insulating material applied on the paper material,
the method including
applying the two-dimensional insulating material onto a partial section of the two-dimensional paper material, wherein at least one overlapping region, in which the outer sleeve has a material thickness at least twice the thickness of the paper material, is not provided with the insulating material.

14. The method according to claim 13, the method including applying the two-dimensional insulating material onto the partial section of the two-dimensional paper material prior to producing the blank for the outer sleeve from the paper material that is partially provided with the insulating material.

15. The method according to claim 14, the method including applying the two-dimensional insulating material in the form a material strip onto the paper material in the form a material strip, wherein as viewed in the longitudinal direction of the material strip at least one rectangular section of the paper material remains exposed, and cutting out or punching out of the blank for the outer sleeve.

16. The method according to claim 15, the method including removing the material strips of the insulating material and the paper material from a respective coil.

17. The method according to claim 15, the method including cutting out or punching out the blank for the outer sleeve in a manner that a lateral edge of the blank, to which edge the overlapping region adjoins, is arranged non-parallel to a first lateral edge of the material strips.

18. The method according to claim 15, the method including cutting out or punching out the blank for the outer sleeve in a manner that a lateral edge of the blank, to which edge the overlapping region adjoins, is arranged in parallel to a first lateral edge of the material strips.
